(19) United States
(12) Patent Application Publication
(10) Pub. No.: US 2003/0122463 A1
(43) Pub. Date: Jul. 3, 2003

(54) Transparent electrode substrate

(76) Inventors: Mao-Kuo Wei, Hsin Chu (TW); Jih-Yi Wang, Hsin Chu (TW)

Correspondence Address: BIRCH STEWART KOLASCH & BIRCH, PO BOX 747, FALLS CHURCH, VA, 22040-0747, US

(21) Appl. No.: 10/321,366

(22) Filed: Dec. 18, 2002

(30) Foreign Application Priority Data
Dec. 31, 2001 (TW) 090133400

(51) Int. Cl. H01J 1/88

(52) U.S. Cl. 313/244

(57) ABSTRACT

A transparent electrode substrate. The transparent electrode substrate includes a transparent substrate and a transparent anode. In this case, a first surface of the transparent substrate has several microstructures, and each of the microstructures has a maximum height of 100 μm. The transparent anode is formed on a second surface of the transparent substrate that is opposite to the first surface. Furthermore, the invention also discloses another transparent electrode substrate, which includes a transparent substrate, a transparent thin film, and a transparent anode. The transparent thin film is formed on a first surface of the transparent substrate. The transparent thin film has a plurality of microstructures, each of which has a maximum height of 100 μm. The transparent anode is formed on a second surface of the transparent substrate opposite to the first surface.

### BACKGROUND OF THE INVENTION

1. Field of Invention

The invention relates to a transparent electrode substrate and, in particular, to a transparent electrode substrate that has microstructures.

2. Related Art

In a light-emitting device, most light emitted from inside of the device is lost while transferring to the outside of the device. Therefore, the external quantum efficiency of the light-emitting device is reduced.

According to Snell's Law, when a beam of light goes through an interface, the product of the refraction index and the sine of the incident angle in the incident medium are equal to that in the refractive medium. In light-emitting devices, the refraction index of the transparent substrate n₃ (1.4-1.5) is larger than that of air (1). When a beam of light propagates out from the transparent substrate and the incident angle is greater than sin⁻¹(1/n₃), the light will be totally reflected. The light is restricted to propagation within the transparent substrate, resulting in the substrate waveguide phenomenon. However, when the incident angle is smaller than sin⁻¹(1/n₃), light will propagate out of the element. One thus sees that only part of the light generated by the light-emitting device that can propagate out of the element. The rest results in the substrate waveguide phenomenon inside the substrate.

In conventional, a substrate with a high refraction index is used and convex lenses are attached on the light-emitting surface to increase the external quantum efficiency. As shown in FIG. 1, convex lenses 31 with a diameter between 2 mm and 3 mm are attached on the light-emitting surface of a conventional transparent electrode substrate 3. If the material of the convex lenses 31 is the same as that of the transparent substrate 32, the light flux of the light-emitting element can be increased by 60% to 100%. If lenses with a higher refraction index are used, the light flux of the element can be increased by 200%. In this case, a refraction index matching oil is employed to attach the convex lenses 31 to the light-emitting surface. This is not suitable for long-term use. Another commonly used technique is that disclosed in the U.S. Pat. Nos. 5,936,347 and 6,080,030. The semi-convex lenses or semi-concave lenses are directly formed on a glass substrate by hot-embossing method, thereby increasing the external quantum efficiency of the element. However, the operation temperature for glass hot-embossing method is very high and is likely to make the glass locally deformed. Furthermore, the operation time (for increases and decreases in temperature) is too lengthy for use in mass production.

The lens used in the above-mentioned prior art have the drawbacks of being too thick (millimeter scales) and having large diameter. It is not suitable for the trend of developing compact light-emitting devices. Moreover, when refraction index matching oil is used to attach the lenses to the light-emitting surface, the lenses may easily be stripped off so as to decrease the lifetime of element. Besides, if the glass is locally deformed, the product yield in the manufacturing processes will be affected.

### SUMMARY OF THE INVENTION

It is an objective of the invention to provide a transparent electrode substrate to increase external quantum efficiency, to simplify the processes of manufacturing, to prolong the lifetime, and to have a compact and light structure.

To achieve the above objective, the transparent electrode substrate includes a transparent substrate and a transparent anode. In this invention, several microstructures are formed on a first surface of the transparent substrate, wherein each of the microstructures has a maximum height of 100 μm. The transparent anode is formed on a second surface of the transparent substrate opposite to the first surface.

The invention also provides another transparent electrode substrate, which includes a transparent substrate, a transparent thin film, and a transparent anode. The transparent thin film is formed on a first surface of the transparent substrate. The transparent thin film has a plurality of microstructures, each of which has a maximum height of 100 μm. The transparent anode is formed on a second surface of the transparent substrate opposite to the first surface.

According to this invention, the transparent electrode substrate has several microstructures to increase the external quantum efficiency of the element. It can achieve the goals of saving energy and being environmentally friendly. Moreover, this invention combines the microstructures and the transparent substrate, so that the thickness of the whole substrate and device structure can be minimized so as to achieve the requirement for compact electric products. Furthermore, the transparent electrode substrate according this invention without the refraction index matching oil is suitable for long-term use. The glass substrate is not necessary, so that the partial warps of the substrate can be avoided during the manufacturing.

### BRIEF DESCRIPTION OF THE DRAWINGS

The invention will become more fully understood from the detailed description given in the herein below illustration, and thus are not limitative of the present invention, and wherein:

FIG. 1 is a schematic view of the conventional transparent electrode substrate;

FIG. 2 is a schematic view of an embodiment of the disclosed transparent electrode substrate;

FIGS. 3A to 3C are schematic views of the microstructures of the invention; and

FIG. 4 is a schematic view of another embodiment of the disclosed transparent electrode substrate.

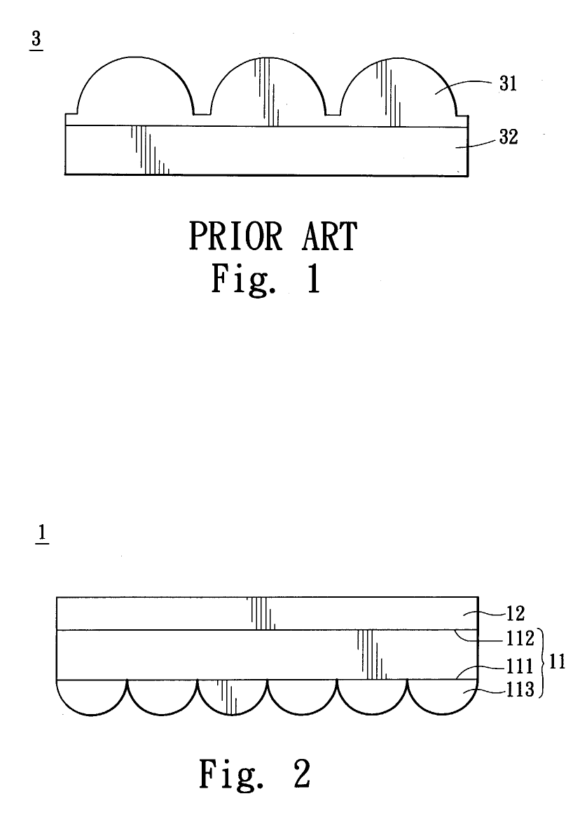

### DETAILED DESCRIPTION OF THE INVENTION

As shown in FIG. 2, an embodiment of a transparent electrode substrate 1 includes a transparent substrate 11 and a transparent anode 12. In this embodiment, a first surface 111 of the transparent substrate 11 has several microstructures 113, and the maximum distance from the top of each microstructure 113 to the first surface 111 is about 100 μm. The transparent anode 12 is formed on a second surface 112 of the transparent substrate 11 opposite to the first surface 111.

The transparent substrate 11 may be a plastic substrate or a flexible substrate. In this case, the plastic substrate or the flexible substrate may be a polycarbonate (PC) substrate, a polyester (PET) substrate, a cyclic olefin copolymer (COC) substrate, or a metallocene-based cyclic olefin copolymer (mCOC) substrate. The thickness of the transparent substrate 11 is between 0.2 mm and 5 mm.

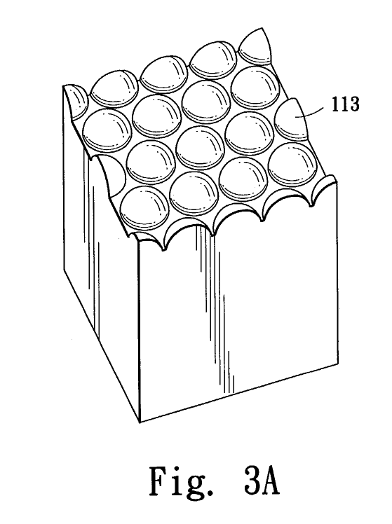

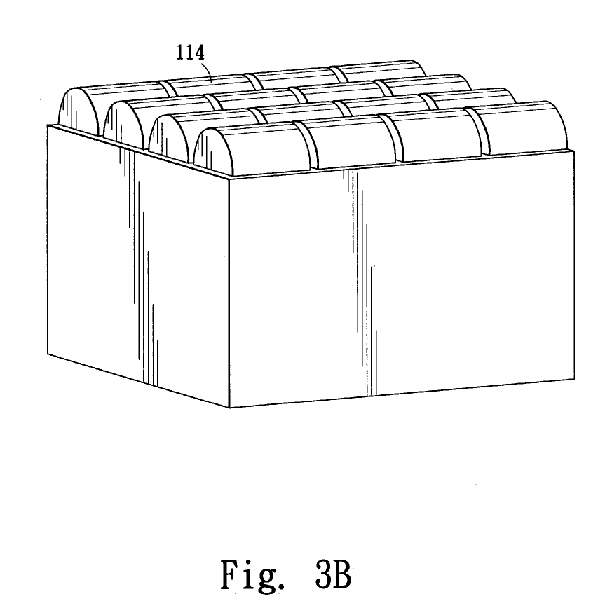

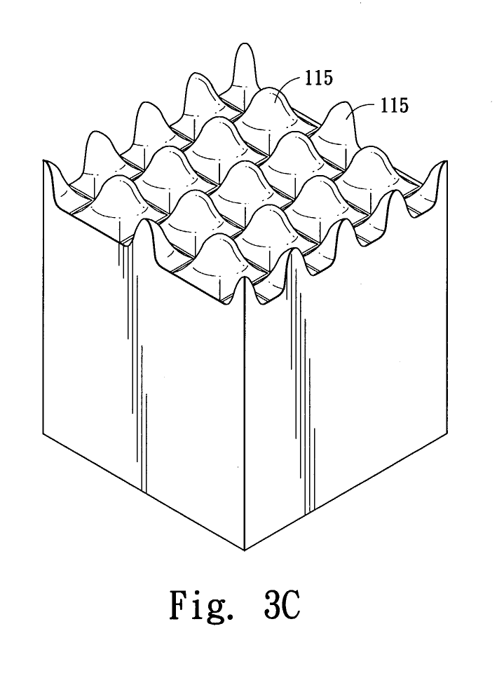

As shown in FIG. 2, the first surface 111 of the transparent substrate 11 has several microstructures 113. The distance from the top of each microstructure 113 to the first surface 111 is between 5 μm and 100 μm. In the current embodiment, each of the microstructures 113 has a curved surface. The surface may be like a spherical cap (as shown in FIG. 3A). The diameter of the base of the spherical cap is between 10 μm and 500 μm. Certainly, the microstructures 113 can also be cylindrical caps 114 (as shown in FIG. 3B). The cylindrical cap 114 has a diameter between 10 μm and 500 μm and a length between 10 μm and 500 μm. Moreover, the microstructures 113 may be a protruding curved surface 115 with a regular polygon border. An example with a square border is shown in FIG. 3C. The perimeter of the square border of the protruding curved surface 115 is between 10 μm and 500 μm.

The microstructures 113 in the embodiment are used to enhance the external quantum efficiency of the transparent electrode substrate 1. In the transparent electrode substrate 1, which is a flat substrate, the refraction index of the transparent substrate 11 n_{sub} is greater than that of air. Therefore, when the incident angle of a beam of light produced inside the element is greater than a threshold angle sin⁻¹(1/n_{sub}) at the transparent substrate 11/air interface, it will be totally reflected, resulting in the substrate waveguide phenomenon. The microstructures 113 in the embodiment converge light beams with incident angles greater than the threshold angle and guide them out of the element. This is why the invention can greatly increase the external quantum efficiency of the transparent electrode substrate 1.

In the current embodiment, the transparent substrate 11 can be formed by injection molding method. Two molds (not shown) are used in the injection molding method. The surface of the first mold is an optics-graded smooth plane. The surface of the second mold has microscope structures. After being heated and melted, plastic particles are ejected into the space between the two molds to make a transparent substrate 11 with the microstructures.

On the other hand, the transparent substrate 11 can be formed by hot-embossing method. This method requires an optics-graded platform (not shown). The transparent substrate 11 is placed on to the platform and heated to a working temperature. The hot embossing mold is placed on the transparent plastic substrate and imposed by a homogeneous pressure. The hot embossing mold has microstructures to form the transparent substrate 11 with microstructures.

The second surface 112 of the transparent substrate 11 is an optics-graded smooth plane without any geometric structure. The transparent anode 12 is formed on the second surface 112 by method of sputtering or ion plating. The transparent anode 12 can be made of a conductive metal oxide such as indium-tin oxide (ITO) or aluminum-zinc oxide (AZO). The thickness of the transparent anode 12 is above 500 Å.

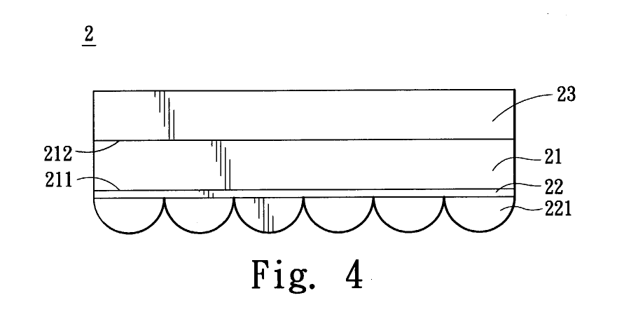

As shown in FIG. 4, in another embodiment of the invention, a transparent electrode substrate 2 includes a transparent substrate 21, a transparent thin film 22, and a transparent anode 23. The transparent thin film 22 is formed on a first surface 211 of the transparent substrate 21. The transparent thin film 22 has several microstructures 221 with a maximal height of 100 μm. A second surface 212 of the transparent substrate 21 opposite to the first surface 211 is formed with the transparent anode 23.

In this case, the transparent substrate 21 may be a plastic substrate, a flexible substrate, or a glass substrate. The plastic substrate and the flexible substrate may be a polycarbonate (PC) substrate, a polyester (PET) substrate, a cyclic olefin copolymer (COC) substrate, or a metallocene-based cyclic olefin copolymer (mCOC). The thickness of the transparent substrate 21 is between 0.2 mm and 5 mm.

The transparent thin film 22 is formed on the first surface 211 of the transparent substrate 21 by an adhesive method. The adhesive method is to use thermal cured glue or UV cured glue to attach the transparent thin film 22 on the transparent substrate 21. The surface of the transparent thin film 22 has several microstructures 221. The height of each microstructure 221 is between 5 μm and 100 μm. In the current embodiment, the features and functions of the microstructures 221 are the same as those in the first embodiment.

The second surface 212 of the transparent substrate 21 is an optics-graded smooth plane without any geometric structure. The transparent anode 23 is formed on the second surface 212 by method of sputtering or ion plating. The transparent anode 23 can be made of a conductive metal oxide such as indium-tin oxide (ITO) or aluminum-zinc oxide (AZO). The thickness of the transparent anode 23 is above 500 Å.

The disclosed transparent electrode substrate according to this invention has special microstructures. In the provided embodiments, the function of the microstructures is to efficiently transmit light out of the element and to increase the external quantum efficiency of the transparent electrode substrate. In comparison with the prior art, the disclosed device has strongly reduced manufacturing time and lowered cost. The microstructures can effectively reduce the thickness of the device to attach the requirement for compact electric products. Furthermore, the transparent electrode substrate according to this invention employs thermal cured glue or UV cured glue to attach the transparent thin film, instead of index matching oil, so the lifetime of transparent electrode substrate can be prolonged and the reliability of transparent electrode substrate can be improved. Moreover, the glass substrate is not necessary, so that the partial warps of the substrate can be avoided during the manufacturing.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A transparent electrode substrate, comprising:
a transparent substrate, which has a first surface and a second surface opposite to the first surface, the first surface being formed with a plurality of microstructures and each of the microstructures having a maximal height of 100 μm; and
a transparent anode, which is formed on the second surface of the transparent substrate.

2. The transparent electrode substrate of claim 1, wherein the transparent substrate is a plastic substrate.

3. The transparent electrode substrate of claim 1, wherein the transparent substrate is a flexible substrate.

4. The transparent electrode substrate of claim 1, wherein the transparent substrate is formed by injection molding method.

5. The transparent electrode substrate of claim 1, wherein the transparent substrate is formed by hot-embossing method.

6. The transparent electrode substrate of claim 1, wherein the thickness of the transparent substrate is between 0.2 mm and 5 mm.

7. The transparent electrode substrate of claim 1, wherein the height of each microstructure is about 5 μm to 100 μm.

8. The transparent electrode substrate of claim 1, wherein the microstructures have a curved surface.

9. The transparent electrode substrate of claim 8, wherein the curved surface has a spherical shape with a diameter between 10 μm and 500 μm.

10. The transparent electrode substrate of claim 8, wherein the curved surface has a cylindrical shape with a diameter between 10 μm and 500 μm and a length between 10 μm and 500 μm.

11. The device of claim 8, wherein the curved surface is a protruding surface having a regular polygon border with a perimeter between 10 μm and 500 μm.

12. A transparent electrode substrate, comprising:
a transparent substrate;
a transparent thin film, which is formed on a first surface of the transparent substrate, the transparent thin film having a plurality of microstructures and each of the microstructures having a maximal height of 100 μm; and
a transparent anode, which is formed on a second surface of the transparent substrate opposite to the first surface.

13. The transparent electrode substrate of claim 12, wherein the transparent substrate is a plastic substrate.

14. The transparent electrode substrate of claim 12, wherein the transparent substrate is a flexible substrate.

15. The transparent electrode substrate of claim 12, wherein the transparent substrate is a glass substrate.

16. The transparent electrode substrate of claim 12, wherein the thickness of the transparent substrate is between 0.2 mm and 5 mm.

17. The transparent electrode substrate of claim 12, wherein the transparent thin film is formed on the first surface by an adhesive method.

18. The transparent electrode substrate of claim 12, wherein the microstructures have a curved surface.

19. The transparent electrode substrate of claim 18, wherein the curved surface has a spherical shape with a diameter between 10 μm and 500 μm.

20. The transparent electrode substrate of claim 18, wherein the curved surface has a cylindrical shape with a diameter between 10 μm and 500 μm and a length between 10 μm and 500 μm.

21. The transparent electrode substrate of claim 18, wherein the curved surface is a protruding surface having a regular polygon border with a perimeter between 10 μm and 500 μm.
